(19) United States
(12) Patent Application Publication
(10) Pub. No.: US 2005/0163921 A1
(43) Pub. Date: Jul. 28, 2005

(54) Method of repairing a workpiece

(75) Inventors: Bill L. Looper, Wichita, KS (US); Mark A. Ofsthun, Wichita, KS (US); Roger L. Sellers, Wichita, KS (US); Benton L. Wilgers, Wichita, KS (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: The Boeing Company

(21) Appl. No.: 10/763,647

(22) Filed: Jan. 23, 2004

(51) Int. Cl. B32B 35/00; H05H 1/26; B05D 3/04

(52) U.S. Cl. 427/140; 427/446; 427/307; 427/331

(57) ABSTRACT

A method for repairing minor defects in a workpiece using flame spraying is provided. The method includes first providing a workpiece having a defect and an area proximate to the defect. The method also includes routing a portion of the workpiece, including the defect, such that the routing removes at least a portion of the workpiece proximate to the defect. The depth to which the workpiece is routed may be controlled with a micro-stop countersink apparatus. A router bit is generally plunged into the workpiece in a direction orthogonal to the surface of the workpiece such that the routed portion of the workpiece defines a sidewall extending generally orthogonal to the workpiece and a conical bottom surface. The portion of the workpiece that has been removed by routing is then flame sprayed such that new material is added to fill the portion of the workpiece that has been routed.

### BACKGROUND OF THE INVENTION

1) Field of the Invention

The present invention relates to repairing a workpiece and, more specifically, to a method for repairing minor defects in a workpiece using flame spraying.

2) Description of Related Art

It is common to repair surface defects in a variety of workpieces, such as the skin of an aircraft, a marine vehicle, a structural member, or the like. With respect to an aircraft, for example, defects may result from drill starts, scratches, and minor surface blemishes caused by handling damage. Drill starts are defects in the surface of a material that are formed when a mechanic drilling a hole into the material realizes that the hole location is off, but still accidentally touches the bit of the drill on the surface to make a small hole. In addition, handling damage during manufacturing and maintenance as well as runway debris may also cause defects in the aircraft skin.

Flame spray repair is one method used to repair minor defects and scratches in various types of materials. For example, the aircraft industry uses this method of repair to reduce surface defects so as to correspondingly reduce stress concentrations, maintain appearance, and decrease sources of turbulence (drag) along the aircraft surface. The method generally includes routing an oversized area to remove the defect, grit blasting the area, and then filling the area using flame sprayed aluminum. The area is then sanded and polished to achieve the desired surface finish.

Flame spraying is one of several types of thermal spraying processes. Thermal spraying is also termed “metallizing” and includes electric-arc spraying and plasma-arc spraying, among others. Flame spraying requires a heat source, a propelling means, and feed material to produce the desired coating on the damaged area. Flame spraying utilizes combustible fuel gas (such as acetylene, propane, natural gas, or sometimes hydrogen) which reacts with oxygen or air to heat particles being sprayed onto the workpiece. In addition, a blast gas may be provided in order to aid in accelerating the heated particles and propelling them from the heating zone toward the surface to be coated and/or to cool the workpiece and the coating being formed thereon. When flame spraying, the molten particles flatten upon impact against the workpiece, adhere to the workpiece, and then contract due to cooling. The final cooled coating is characterized by tensile stresses as the individual “splats” are restrained by the workpiece and adjacent adhering particles from reaching a state of zero stress. A more detailed discussion of flame spraying is discussed in U.S. Pat. Nos. 5,268,045 and 4,634,611 and the references cited therein.

Prior flame spraying techniques defined an area to be routed that was larger than the actual damaged area. The technique used was termed “blendout,” where a dished out cavity is created to remove the damaged area and a portion of the surrounding area. For example, a prior art router bit required a minimum width of at least 20 times the depth of the blendout, with the router bit having a rounded cutting profile (See FIG. 1). It was also believed that the edges of the area routed and the undamaged area needed to be smooth to minimize stress concentrations. As such, sharp edges created by the router bit within the aircraft skin were undesirable because of the potential for stress concentrations (See FIG. 1). Thus, the bottom surface of the dished out cavity was also rounded.

However, additional innovations in flame spray repair are desired to promote more efficient and less wasteful preparation of the workpiece. Current methods of routing the damaged area require taking out a larger area than the actual damaged area to ensure that all cut edges are blended smoothly with the surrounding undamaged areas. Prior engineering requirements specified that a smoothly blended area ensured longer fatigue life as stress concentrations were reduced. Additionally, the router bit used to cut the workpiece is generally of a large diameter having a single cutting edge, such that routing around edges or fastener holes is difficult due to decreased visibility and stability of the router bit.

It would therefore be advantageous to provide a flame spraying technique that would reduce the area removed to repair a defect. In addition, it would be advantageous to utilize a router bit that was easier to control its depth and location, as well as being able to maneuver around small areas when removing the defect. Finally, it would be advantageous to provide a router bit that improved preparation for flame spraying without decreasing fatigue life.

### SUMMARY OF THE INVENTION

The present invention provides an improved method for repairing minor defects in a workpiece using flame spraying. The method includes first providing a workpiece, such as an aircraft skin, having a defect and an area proximate to the defect. The method further includes routing a portion of the workpiece, including the defect, such that routing removes at least a portion of the workpiece proximate to the defect. Routing further comprises controlling a depth to which the workpiece is routed with a micro-stop countersink apparatus, such as by controlling the depth to permit removal in predefined increments. The portion of the workpiece that has been removed by routing is then flame sprayed such that new material is added to fill the portion of the workpiece that has been routed.

In one embodiment, routing comprises plunging a router bit into the portion of the workpiece including the defect. The router bit contacts the defect and the area proximal to the defect in a direction generally orthogonal to the workpiece such that the routed portion of the workpiece is defined by a sidewall extending generally orthogonal to the workpiece and a conical bottom surface.

The router bit may have two cutting edges. The router bit may also have a relief angle of less than three degrees on the cutting edges. Further, the router bit may have a diameter of at least 20 times a depth of the portion of the workpiece that has been removed by routing. Also, the routing may further include routing the workpiece to a depth of 10% or less of the thickness of the workpiece.

The method could also comprise additional steps. For example, the method could comprise blasting the portion of the workpiece that has been routed using grit to remove foreign particles prior to flame spraying. The grit blasting improves the adhesion of the flame sprayed material, as well as develops compressive residual stresses within the workpiece. The method could also comprise sanding the portion of the workpiece that has been flame sprayed. In addition, the method could include polishing the portion of the workpiece that has been flame sprayed following sanding.

In another embodiment, the method includes providing a workpiece, such as an aircraft skin, having a defect and an area proximate to the defect. The method further includes plunging a router bit into the portion of the workpiece including the defect. The router bit contacts the defect and the area proximal to the defect in a direction generally orthogonal to the workpiece to remove a portion of the workpiece including the defect and at least a portion of the workpiece proximate to the defect. The routed portion of the workpiece is defined by a sidewall extending generally orthogonal to the workpiece and a conical bottom surface. The method also includes flame spraying the portion of the workpiece that has been removed by routing such that new material is added to fill the portion of the workpiece that has been routed.

As before, the depth to which the router bit is plunged may be controlled with a micro-stop countersink apparatus. In this regard, the depth may be controlled to permit removal in predefined increments, and plunging the router bit comprises plunging the router bit to a depth of 10% or less of the thickness of the workpiece.

The present invention provides a method capable of removing less of the workpiece proximal to the defect than prior methods when preparing the workpiece for flame spraying. The current method includes a router bit having a profile that produces a cut in the workpiece that has a sidewall extending substantially perpendicular to the surface of the workpiece being repaired, as well as a conical bottom surface, such that the routed portion has sharp edges defined between the sidewall and the conical bottom surface. Previous methods were generally premised on the belief that sharp edges produced stress concentrations that would decrease fatigue life. In contrast to conventional wisdom, however, the repair method of the present invention is acceptable in terms of fatigue life even though the portion of the workpiece that is routed does not have a smooth transition. Therefore, the diameter of the router bit can be more closely matched to the defect being removed.

The design of the router bit used with the method of the present invention may remove less material than did prior cutters due to its non-rounded profile and shallow relief angle. The router bit includes multiple cutting edges that improve the stability and control of the router bit during routing. The router bit is also easier to control in terms of depth and location given that the router bit may be plunged into the workpiece while routing, as opposed to the sweeping motion in which prior router bits were moved. Thus, the router bit may be used to repair areas of the workpiece that are near fasteners or other hard to reach areas since a rounded blendout is not required. The plunging action of the router bit also enables the router bit to quickly remove material, which reduces the amount of time needed to make the repair.

The micro-stop countersink apparatus employed by at least some embodiments of the present invention allows the depth of the router bit to be closely controlled, which also permits the router bit to be used near fasteners and in very thin sheet metal. The micro-stop countersink apparatus also effectively controls the depth to which the router bit is plunged into the workpiece at predetermined increments. Thus, the router bit is prevented from penetrating below the workpiece to damage any underlying materials. The micro-stop countersink apparatus also improves the repeatability and visibility of the user when preparing the workpiece for flame spraying.

### BRIEF DESCRIPTION OF THE DRAWINGS

The foregoing and other advantages and features of the invention, and the manner in which the same are accomplished, will become more readily apparent upon consideration of the following detailed description of the invention taken in conjunction with the accompanying drawings, which illustrate preferred and exemplary embodiments, but which are not necessarily drawn to scale, wherein:

FIG. 1 is a side view illustrating a prior art router bit and blendout resulting from routing prior to flame spraying;

FIGS. 2a-f are side views illustrating a method of repairing a workpiece according to one embodiment of the present invention;

FIG. 3 is a side view of the router bit used in the method shown in FIGS. 2a-f;

FIG. 4 is another side view of the router bit of FIG. 3 used in the method shown in FIGS. 2a-f;

FIG. 5 is bottom view of the router bit of FIG. 3 used in the method shown in FIGS. 2a-f;

FIG. 6 is a perspective view of the router bit of FIG. 3 used in the method shown in FIGS. 2a-f;

FIG. 7 is an illustration demonstrating a profile of a cut in a workpiece using the router bit of FIG. 3;

FIG. 7a is a detail view of the profile of a cut in a workpiece shown in FIG. 7; and

FIG. 8 is a side view of a micro-stop countersink unit used with the router bit of FIG. 3.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

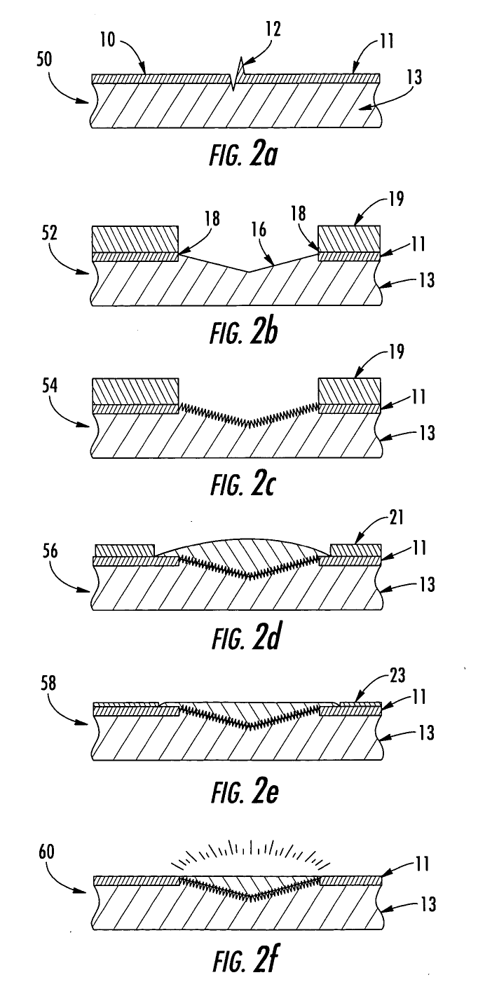

Referring now to the drawings and, in particular, to FIG. 2a, there is shown a workpiece 10 having a layer of sheet material 11 on the surface and adjacent to a layer of base material 13 underlying the layer of sheet material. The term workpiece 10 may include any number of materials, metallic or nonmetallic. For example, the top layer of sheet material 11 may be an aircraft skin, and more specifically, aluminum skin clad. However, the method of repairing a workpiece 10 described herein would be advantageous for repairing workpieces used in a wide variety of applications, such as workpieces employed in the aerospace, transportation, marine, and construction industries, and the like, where repairing small defects 12 would be advantageous for extending service life. Additionally, while the workpiece 10 depicted in FIG. 2a comprises a layer of sheet material 11 upon a layer of base material 13, the workpiece may be a monolithic structure or may be comprised of additional layers, if so desired.

The workpiece 10 includes any of a variety of defects 12, such as a drill spot, a scratch, an imperfection, or a shallow surface blemish. The defect 12 may extend through cladding of the sheet material 11 into the base material 13, or the defect may exist only in the sheet material.

The present method incorporates steps to repair a workpiece 10 having a defect 12. Once a workpiece having a defect 12 has been provided, as shown in step 50, a protective layer of abrasion-resistant material, such as mylar maskant 19, is applied adjacent to the area to be repaired so as to protect the areas surrounding the area to be repaired, as shown in FIG. 2b. The workpiece 10 is then routed using a router bit 14 to produce a cutout area 16, as illustrated in step 52. The router bit 14 contacts the workpiece 10 such that the cutout area 16 includes the defect 12 and an area 18 proximal to the defect. Thus, the router bit 14 removes the defect 12 and a relatively small amount of material proximal to the defect to produce the cutout area 16.

The routing step 52 is preferably performed by plunging the router bit 14 into the workpiece 10 to produce the cutout area defined by sidewalls 20 and a conical bottom surface 22. In this regard, the sidewalls 20 extend approximately perpendicular to the surface of the workpiece 10. Moreover, a sharp edge or corner is generally defined between the intersection of the sidewalls 20 and the conical bottom surface 22.

Following routing, the cutout area 16 is then blasted using grit to remove any foreign particles located within the cutout area, as shown in step 54 and FIG. 2c. Grit blasting could use a conventional gun apparatus to propel grit with a gas such as argon or air to produce a rough surface finish along the cutout area 16. A rough surface finish promotes better adhesion of the new material within the cutout area 16 that is subsequently deposited during flame spraying. In addition, grit blasting produces compressive residual stresses within the cutout area 16, which is known in the art as improving fatigue performance.

Once the cutout area 16 is sufficiently grit blasted, the workpiece 10 is flame sprayed, as shown in step 56 and FIG. 2d. A protective shield 21, typically comprised of sheet metal or duct tape, may be applied adjacent to the area to be repaired prior to flame spraying. The protective shield helps to shield the areas of the workpiece 10 adjacent to the area being repaired from excessive heat produced during flame spraying, as well as to divert overspray material from contacting areas adjacent to the area being repaired. As shown in step 56, flame spraying deposits new material such that the new material fills the cutout area 16 and is built up to a required thickness above the upper sheet material 11. Flame spraying may be performed using a conventional thermal plasma gun or similar method to sufficiently heat the new material and deposit the new material on the workpiece 10. The new material is preferably pure aluminum when flame spraying aluminum skin clad, but may be any other suitable metal or like material depending on the type of workpiece material being repaired.

The method may also include finishing procedures. For example, as shown in step 58 and FIG. 2e, the repaired area may be sanded, at least initially by means of a drill motor and sanding disk to remove any excess material applied during flame spraying. In addition, the workpiece 10 can be hand sanded to achieve a consistent surface level between the area repaired and the adjacent areas. A layer of tape 23 or other like material may be placed adjacent to the area to be repaired to protect the repaired area during sanding. The repaired area may then be polished to achieve the desired surface finish and luster to match the adjacent areas of the workpiece 10, as shown in step 60 and FIG. 2f. It may be desirable to apply a temporary protective coating to the repaired area following the polishing step 60.

Although FIGS. 2a-f illustrate several steps in repairing the workpiece 10, it is understood that the method of the present invention should not be limited to those steps. For example, it may be desirable to only perform the routing step 52 and not the grit blasting, 54, flame spraying 56, sanding 58, and polishing 60 steps. Alternatively, only the step of polishing 60 could be removed if a fine surface finish was not needed in particular areas of the workpiece 10.

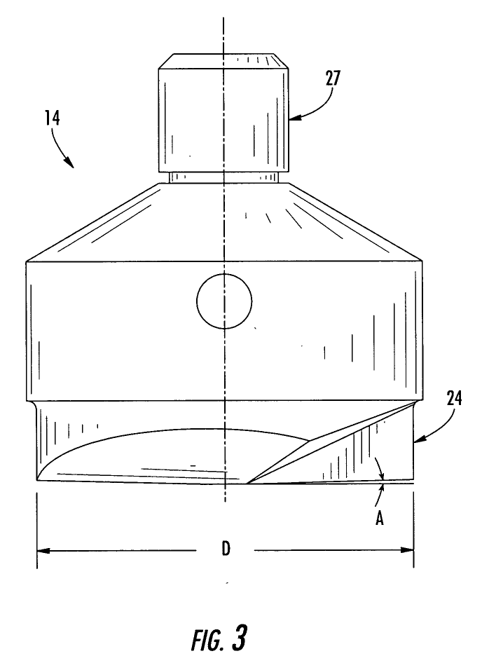

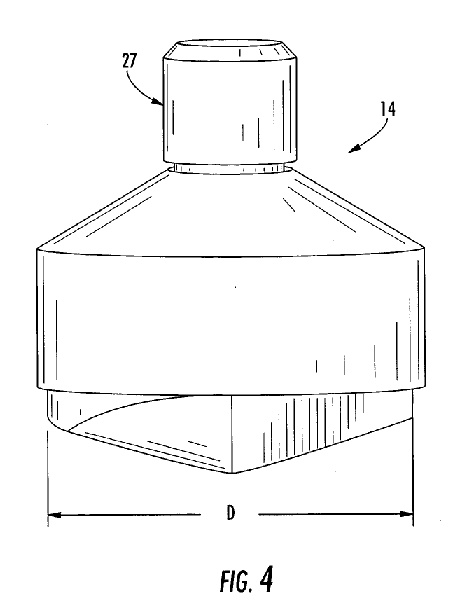

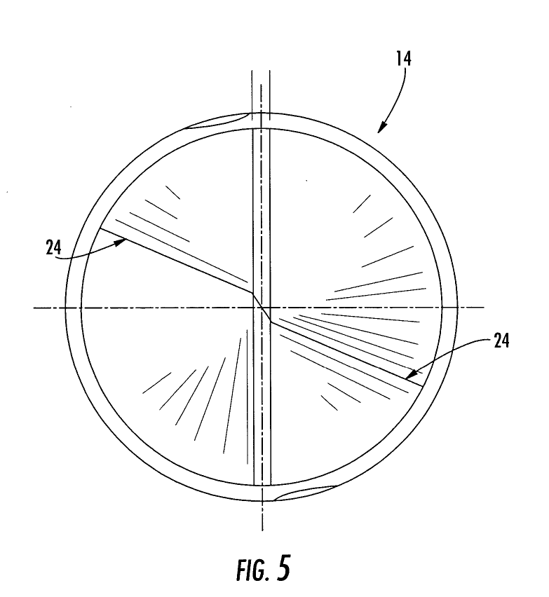

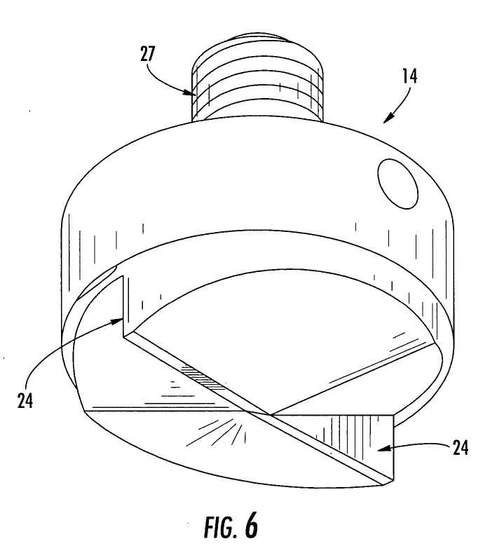

The router bit 14 used to perform the routing step is shown in FIGS. 3-6. The router bit 14 of one advantageous embodiment generally defines an outer diameter D, and includes two cutting edges 24, and a shank 27. FIG. 3 illustrates that the cutting edges 24 of this embodiment of the router bit 14 have a relief angle A of approximately less than three degrees, such that the conical bottom surface of a cutout also correspondingly defines an interior angle in excess of 174 degrees. The cutting edges 24 are located substantially opposite of one another, as shown in FIG. 5. Defining cutting edges 24 on opposite sides of the router bit 14 provides the router bit with improved stability, as well as adequate clearance for each cutting edge when removing material during routing.

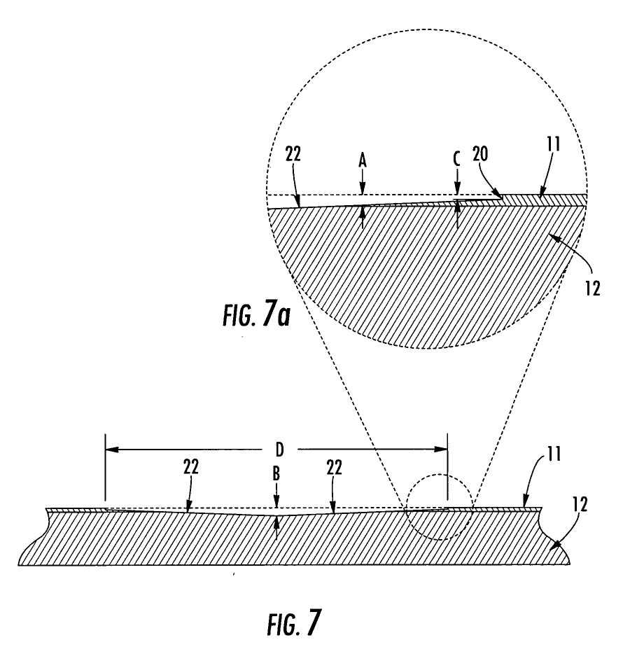

Routing using a small relief angle A ensures that a minimal amount of area 18 proximal to the defect 12 is removed. The router bit 14 includes a profile that defines the cutout 16 illustrated in FIGS. 2 and 7. FIG. 7 demonstrates that the cutting edges 24 are capable of removing material to a depth B. The shape of the conical bottom surface 22 is defined by the relief angle A of the cutting edges 24, while the sidewalls 20 extend to a depth C that is approximately orthogonal to the outer sheet material 11. The overall cutout 16 is a generally circular shape, as the router bit 14 has a circular cross section as shown in FIG. 5. Preferably, the outer diameter D of the router bit 14 is at least 20 times the depth B that is defined by the cutout 16. For example, if the outer diameter D of the router bit 14 is 0.040 inches, the depth B of the cutout 16 could be approximately 0.010 inches. Additionally, the depth B is generally less than 10% of the workpiece 10 thickness.

It is understood that the router bit 14 may comprise different profiles such that the cutting edges 24 extend at varying relief angles A, or the router bit may be used to produce different depths B, C depending on the type of defect 12 on the workpiece 10. Similarly, the diameter D may be varied such that the diameter is not at least 20 times the depth B defined in the cutout 16. For example, for deeper defects 12, a larger diameter D could be used in conjunction with a larger depth B. Alternatively, for very shallow or superficial defects 12, a smaller diameter D could be used to define a shallow depth B. Although the illustrated router bit 14 includes two cutting edges 24, it is also understood that different numbers of cutting edges may be employed to accommodate different materials and produce different surface finishes.

The term “router bit” is not meant to be limiting, and it is understood that the router bit 14 could by any rotary tool typically used for cutting, trimming, shaping, or forming a variety of patterns, grooves, shapes or holes in a workpiece such as aircraft skin. Thus, router bit is used generically and includes implements such as cutters, milling cutters, or the like. Additionally, It is understood that the router bit 14 could be formed of many different types of materials, such as a grade of carbide or hard metal, capable of cutting through a metallic or nonmetallic workpiece.

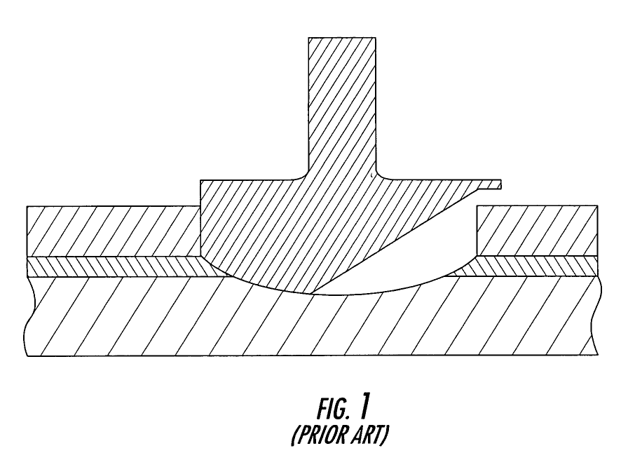

FIGS. 7 and 7a illustrate that the cutout 16 may include sharp edges within the workpiece 10. It was previously believed that a smooth rounded cutout was required so that no sharp edges were formed within the workpiece because it was believed this would produce stress concentrations (See FIG. 1). However, fatigue testing on drill starts demonstrated that including sharp edges within the area to be flame sprayed produced acceptable results. For example, fatigue testing on 63 flexure specimens repaired using a router bit that produced sharp edges within the workpiece and then flame sprayed indicated that 2024-T3 Aluminum having a thickness of 0.032 inches did not reduce fatigue life for drill starts up to a depth of 0.010 inches. In other words, the testing demonstrated that there was no loss in fatigue performance for repairs of up to 10% of the workpiece thickness, and minimal decrease in fatigue performance for deeper repairs.

Thus, a smooth transition between the defect and the surrounding area is not necessarily provided by the method of the present invention. Routing a cutout 16 having sharp edges thus allows the router bit 14 to remove less material surrounding the defect, as the router bit can be more closely matched to the defect. Also, the router bit 14 may be used closer to fasteners and other areas that were previously difficult to route due to the belief that a smooth transition between the defect and surrounding material was required. Additionally, including a router bit 14 having multiple cutting edges advantageously increases the stability of the tool, especially when cutting on curved surfaces.

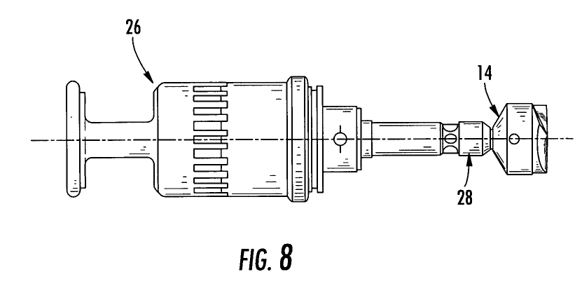

The method of embodiments of the present invention also preferably includes a micro-stop countersink apparatus 26 to control the depth of the router bit 14 when plunging the router bit into the workpiece 10. The micro-stop countersink apparatus 26 is illustrated in FIG. 8 and shows that the router bit 14 may be mounted at its shank 27 to a chuck 28 on the micro-stop apparatus. The micro-stop countersink apparatus 26 essentially causes the router bit 14 to rotate and then plunge much like a drill press into the workpiece 10. Therefore, after a user locates a defect 12, the user aligns the micro-stop countersink apparatus 26 proximate to the defect by hand and then pushes the router bit 14 into the workpiece 10 until the micro-stop countersink apparatus acts to prevent any further penetration of the router bit into the workpiece in a conventional manner.

Preferably the micro-stop countersink apparatus 26 may be adjusted by increments as small as 0.001 inches. Typically, the micro-stop countersink apparatus 26 is adjusted to a desired predetermined depth such that the router bit 14 penetrates the workpiece 10 until the predetermined depth is reached. The micro-stop countersink apparatus 26 may be used by hand, which allows a user to advantageously repair defects 12 in a variety of locations.

Preferably the micro-stop countersink apparatus 26 contacts the surface of the workpiece 10 at approximately a perpendicular angle. Perpendicularity can be readily achieved when positioning the micro-stop countersink apparatus 26 on the surface of the workpiece by hand, especially when the workpiece has a relatively smooth contour, and the size of the defect 12 is small. Generally, the depth and accuracy of the cut can be performed on scrap material prior to performing the routing on the workpiece 10. An example of a micro-stop countersink apparatus 26 that may be used with the method of the present invention is one manufactured by Magnavon Industries Inc. (No. 2140) of Placentia, Calif. The Magnavon micro-stop countersink apparatus 26 operates up to about 10,000 rpm, has 9/32 of shaft travel, 0.001 incremental depth adjustment, and ⅝ diameter cutter capacity.

It is understood that a variety of micro-stop countersink apparatuses 26 may be used with a router bit 14 to define a preferred cutout 16 profile having different depths B, C and diameter D. For example, the micro-stop countersink apparatus 26 may be mounted to a fixture that allows a user to position the micro-stop apparatus on the surface of the workpiece 10. Thus, the user would not have to position the micro-stop countersink apparatus 26 on the surface of the workpiece 10 by hand prior to routing the workpiece. Additionally, a different micro-stop countersink apparatus 26 could be used if more precise depth increments were needed, or vice versa, or if a different sized router bit 14 was required to accommodate various sizes of defects.

Although the micro-stop countersink apparatus 26 is described as plunging the router bit 14 into the workpiece, it is understood that the router bit could be used for longitudinal cutting as well. This would typically be the case when repairing longitudinal defects such as long surface scratches. Thus, the router bit 14 could contact the workpiece 10 and be moved along the surface to remove a linear defect. It is also understood that the router bit 14 of the present invention could be used without the micro-stop countersink apparatus 26. For example, the router bit 14 could be used without the micro-stop countersink apparatus 26 when less precise cuts were needed to repair the workpiece 10.

However, the micro-stop countersink apparatus 26 allows the router bit 14 to be closely controlled, which also permits the router bit to be used near fasteners. Advantageously, the micro-stop countersink apparatus 26 also effectively controls the depth to which the router bit 14 is plunged into the workpiece 10 at predetermined increments. Thus, the router bit 14 is prevented from penetrating below the workpiece 10 to damage any underlying materials. The plunging action of the router bit 14 also enables the router bit to quickly remove material, which reduces the amount of time needed to make the repair. The micro-stop countersink apparatus 26 also improves the repeatability and visibility of the user when preparing the workpiece 10 for flame spraying.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for repairing a workpiece, the method comprising:
providing a workpiece having a defect and an area proximate to the defect;
routing a portion of the workpiece including the defect such that routing removes at least a portion of the workpiece proximate to the defect, wherein routing comprises controlling a depth to which the workpiece is routed with a micro-stop countersink apparatus; and
flame spraying the portion of the workpiece that has been removed by routing such that new material is added to fill the portion of the workpiece that has been routed.

2. The method according to claim 1, wherein the micro-stop countersink apparatus is capable of receiving a router bit, and wherein routing comprises aligning the micro-stop countersink apparatus with the workpiece and then plunging the router bit into the workpiece.

3. The method according to claim 1, wherein routing comprises plunging a router bit into the portion of the workpiece including the defect such that the router bit contacts the defect and the area proximal to the defect in a direction generally orthogonal to the workpiece such that the routed portion of the workpiece is defined by a sidewall extending generally orthogonal to the workpiece and a conical bottom surface.

4. The method according to claim 1, wherein controlling the depth comprises controlling the depth to permit removal in predefined increments.

5. The method of claim 1, wherein routing comprises routing the workpiece with a router bit having two cutting edges.

6. The method according to claim 1, wherein routing comprises routing the workpiece with a router bit having cutting edges with a relief angle of less than 3 degrees.

7. The method according to claim 1, wherein routing comprises routing the workpiece with a router bit having a diameter of at least 20 times a depth of the portion removed by routing.

8. The method according to claim 1, wherein providing the workpiece comprises providing an aircraft skin having a defect.

9. The method of claim 1, further comprising blasting the portion of the workpiece that has been routed using grit to remove foreign particles prior to flame spraying.

10. The method of claim 1, further comprising sanding the portion of the workpiece that has been flame sprayed.

11. The method of claim 10, further comprising polishing the portion of the workpiece that has been flame sprayed following sanding.

12. The method of claim 1, wherein routing further comprises routing the workpiece to a depth of 10% or less of the thickness of the workpiece.

13. A method for repairing a workpiece, the method comprising:
providing a workpiece having a defect and an area proximate to the defect;
plunging a router bit into the portion of the workpiece including the defect, wherein the router bit contacts the defect and the area proximal to the defect in a direction generally orthogonal to the workpiece to remove a portion of the workpiece including the defect such that the routing removes at least a portion of the workpiece proximate to the defect, and wherein the routed portion is defined by a sidewall extending generally orthogonal to the workpiece and a bottom surface; and
flame spraying the portion of the workpiece that has been removed by routing such that new material is added to fill the portion of the workpiece that has been routed.

14. The method according to claim 13, wherein plunging comprises controlling a depth to which the workpiece is routed with a micro-stop countersink apparatus.

15. The method according to claim 14, wherein the micro-stop countersink apparatus is capable of receiving the router bit, and wherein routing comprises aligning the micro-stop countersink apparatus with the workpiece and then plunging the router bit into the workpiece.

16. The method according to claim 14, wherein controlling the depth comprises controlling the depth to permit removal in predefined increments.

17. The method of claim 13, wherein plunging the router bit comprises forming the routed portion to have a conical bottom surface.

18. The method of claim 13, further comprising providing a router bit having two cutting edges.

19. The method according to claim 13, further comprising providing a router bit having cutting edges with a relief angle of less than 3 degrees.

20. The method of claim 13, further comprising providing a router bit having a diameter of at least 20 times a depth of the portion that has been routed.

21. The method according to claim 13, wherein providing the workpiece comprises providing an aircraft skin having a defect.

22. The method of claim 13, further comprising blasting the portion of the workpiece that has been routed using grit to remove foreign particles prior to flame spraying.

23. The method of claim 13, further comprising sanding the portion of the workpiece that has been flame sprayed.

24. The method of claim 23, further comprising polishing the portion of the workpiece that has been flame sprayed following sanding.

25. The method of claim 13, wherein plunging the router bit comprises plunging the router bit to a depth of 10% or less of the thickness of the workpiece.
